(19) United States
(12) Patent Application Publication
(10) Pub. No.: US 2013/0236239 A1
(43) Pub. Date: Sep. 12, 2013

(54) Method for Producing Tailored Sheet Steel Products to be Warm-Formed

(71) Applicants: Max Brandt, Duisburg (DE); Christian Both, Duisburg (DE); Dietmar Schaftinger, Rheinberg (DE); Christian Dornscheidt, Dusseldorf (DE)

(72) Inventors: Max Brandt, Duisburg (DE); Christian Both, Duisburg (DE); Dietmar Schaftinger, Rheinberg (DE); Christian Dornscheidt, Dusseldorf (DE)

(73) Assignee: THYSSENKRUPP TAILORED BLANKS GMBH, Duisburg (DE)

(21) Appl. No.: 13/695,943

(22) PCT Filed: May 2, 2011
(86) PCT No.: PCT/EP2011/056963

§ 371 Date: Jan. 8, 2013

(30) Foreign Application Priority Data
May 3, 2010 (DE) 10 2010 019 258.9

(51) Int. Cl. B23K 31/02

(52) U.S. Cl. CPC B23K 31/02
USPC 403/270; 228/203; 148/529

(57) ABSTRACT

A method includes producing sheet steel products, in which steel blanks or steel strips of different thicknesses and/or material grades are welded together along a joint formed by edges of the steel blanks or steel strips. In order that the welding seam of such a sheet steel product does not lose the hardened microstructure obtained by abrupt cooling during warm forming with heating to an austenization temperature, before the welding process, a viscous liquid, such as a paste, or a solid, pulverulent, or aerosol-like substance that contains at least one component that increases the strength of the weld seam that is to be produced, is applied to at least one weld edge of the steel blanks or steel strips that are to be welded together.

The invention relates to a method for producing sheet steel products, in which steel blanks or steel strips of different thicknesses and/or material grades are welded together along a joint formed by edges of the steel blanks or steel strips, and to a sheet steel product (semi-finished product) which is intended for producing a warm-formed component and which consists of steel blanks or steel strips of different thicknesses and/or material grades which are welded together along a joint.

In modern vehicle construction nowadays, sheet metal blanks are used which are welded together and which are of different thicknesses and/or material grades. This makes it possible to adapt various locations of the subsequent component to local loads, which would otherwise require additional reinforcing parts. As a result, the weight of the relevant component can be reduced. Further, manufacturing costs can be reduced. The sheet metal blanks are generally connected in a butt joint by laser welding. Sheet metal blanks of this type are generally referred to as “tailored blanks” or “tailored welded blanks”. By selectively influencing the welding process, in particular by abruptly cooling the welding seam with water after the joining process, the weld seam is hardened, and this can make the weld seam stronger and more difficult to break (preventing hardness drops), it being possible to set a strength at least equal to that of the basic materials. However, if tailored blanks are shaped into a three-dimensional component by warm forming, the microstructure of the weld seam is homogenised as a result of the heat treatment of the welded semi-finished product. Unfavourable cooling conditions or a lack of positive connection between the shaping tool and the workpiece can result in incomplete conversion of austenite into martensite and in a pro-eutectoid ferrite sediment, resulting in a loss in hardness by comparison with the basic materials.

The object of the present invention is to provide a method for producing tailored sheet steel products to be warm-formed and a corresponding sheet steel product in the form of a semi-finished product, with which it is possible to set the strength of the weld seam to a level which is at least equal to that of the basic materials of the steel sheets to be joined, in such a way that hardness drops in the weld seam can be intercepted even after warm forming with advance heating to an austenisation temperature.

This object is achieved by a method having the features of claim 1 and by a sheet steel product (semi-finished product) having the features of claim 12.

The method according to the invention is characterised in that, before the welding process, a viscous liquid, in particular a paste, or a solid, pulverulent or aerosol-like substance, which contains at least one component which increases the strength of the weld seam which is to be produced, is applied to at least one weld edge of the steel blanks or steel strips which are to be welded together.

By introducing, into the liquid weld pool, at least one component which increases the strength of the weld seam which is to be produced, via at least one of the sheet steel edges which define the joint, an altered primary microstructure is produced having a different chemical composition from the microstructures of the connected basic materials, and—after abrupt cooling in the welding process (for example by quenching with water), heating in the warm forming process (heat treatment above the austenisation temperature) and cooling in the shaping process (direct warm forming or hot stamping), as well as in the process steps of indirect warm forming—has preferably a harder secondary microstructure than the basic materials which are connected by the welding, but at least an equally hard microstructure.

The sheet steel product (semi-finished product) according to the invention is accordingly characterised in that the weld seam thereof—after abrupt cooling, heating to a temperature above the austenisation temperature and further abrupt cooling—has a preferably harder microstructure than the steel blanks or steel strips which are connected by the welding, the microstructure being at least equally hard.

Tests have shown that the strength of the weld seam in laser welding can be increased by introducing in particular carbon into the weld pool.

A preferred embodiment of the method according to the invention provides that oil, in particular mineral oil, and/or grease is used as the viscous liquid. These carbon-containing liquids or solid, pulverulent or aerosol-like substances, which contain at least one component, preferably carbon, which increases the strength of the weld seam which is to be produced, can be obtained relatively cost-effectively and are particularly simple to introduce into the liquid weld poolweld pool.

A further advantageous embodiment of the method according to the invention is characterised in that a liquid in which graphite particles are dispersed is used as the viscous liquid. In this way, carbon can be introduced to the liquid weld pool at a variable concentration, in particular at a relatively high concentration. In this case, the introduction is again possible in a relatively simple manner, for example via a fluid line which is guided along the joint and opens thereon at a distance from the welding beam. In this case, the fluid line can be made substantially rigid, in such a way that it can also be used as a mechanical sensing element for guiding the weld beam along the joint.

The viscous liquid, having the at least one element which increases the strength of the weld seam, can also be applied at a different time from the actual welding process, in a workstation which is independent of the welding device. Preferably, however, the viscous liquid or the solid, pulverulent or aerosol-like substance, which contains at least one element, preferably carbon, which increases the strength of the weld seam, is applied “inline”, that is to say as a concurrent or upstream process in the welding apparatus. By applying the liquid close to the operating point of the weld beam, the viscous liquid can be introduced more reliably and liquid losses can be largely prevented.

As regards a selective introduction of the element which increases the strength into the liquid weld pool, and a low consumption of the liquid which contains the element, it is further advantageous if, in accordance with a preferred embodiment of the method according to the invention, the liquid is of a highly viscous or paste-like consistency. At an ambient temperature of 20° C., the kinematic viscosity of the liquid which contains the element which increases the strength may for example be at least 50×10⁻⁶ m²/s, preferably at least 100×10⁻⁶ m²/s, more preferably at least 500×10⁻⁶ m²/s.

A further preferred embodiment of the method according to the invention provides that the liquid or the solid, pulverulent or aerosol-like substance is selected and/or adjusted, as regards the carbon content thereof, in such a way that the weld seam—after abrupt cooling, heating to a temperature above the austenisation temperature, and further abrupt cooling—has a strength which is at least equal to, preferably at least 100 MPa higher than, more preferably at least 200 MPa higher than the strength of the steel blanks or steel strips which are connected by the welding.

In particular, it is provided that the viscous liquid or the solid, pulverulent or aerosol-like substance is selected and/or adjusted, as regards the carbon content thereof, in such a way that the weld seam—after abrupt cooling, heating to a temperature above the austenisation temperature, and further abrupt cooling—has a strength which is in the range of 1500 MPa to 2000 MPa, preferably in the range of 1700 MPa to 1900 MPa. Alternatively, solid substances, for example in the form of wires, but also pulverulent or aerosol-like substances, which are suitable for preferably increasing the strength of the weld seam which is to be produced, may be used.

Further preferred and advantageous embodiments of the method according to the invention and the sheet steel product according to the invention are specified in the dependent claims.

In the following, the invention is explained in greater detail with reference to the appended drawings, in which:

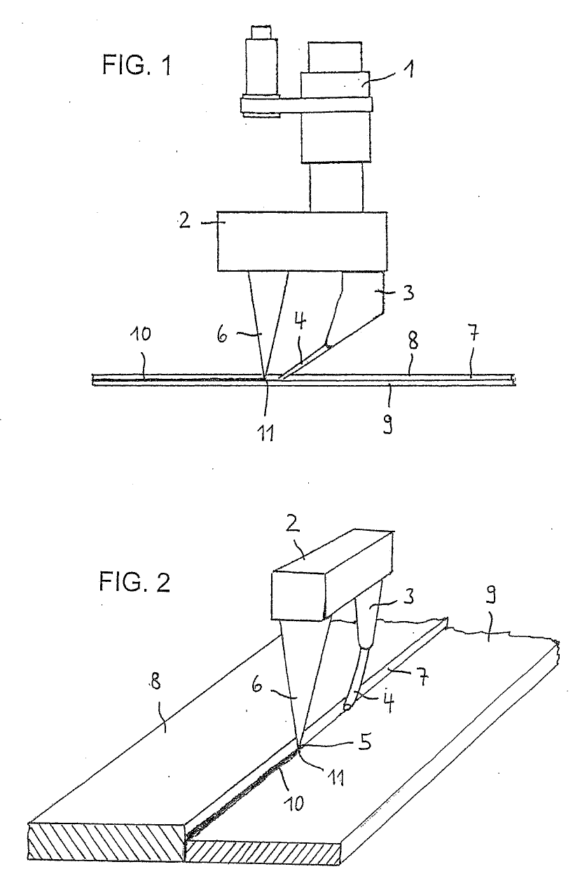

FIG. 1 is a schematic side view of a laser welding device; and

FIG. 2 is a schematic perspective view of a laser welding device and two steel blanks which are to be joined together in a butt joint.

The drawings show part of a laser welding machine, specifically an advancing means 1 for a focussing head (processing head) 2, and an introduction means 3, connected thereto, for applying a viscous, preferably highly viscous liquid, which contains at least one component, preferably carbon, which increases the strength of the weld seam 10 which is to be produced. The liquid is for example a carbon-containing grease paste, a highly viscous oil (mineral oil), or a graphite dispersion. The graphite dispersion preferably consists of finely ground graphite which is dispersed in oil.

The oil or the carbon-containing liquid is introduced via a fluid line 4, which is upstream from the operating point (focus) 5 of the laser beam 6 in the welding direction and opens on the joint 7, which is defined by the steel sheets 8, 9 which are to be welded together. The fluid line 4 is made substantially rigid, and simultaneously acts as a mechanical sensing element or guide element for guiding the laser beam 6 along the joint.

The steel sheets 8, 9 which are to be welded together are steel blanks or steel strips of different material grades or sheet thicknesses. They preferably consist of manganese-boron steel, for example of 22MnB5 steel. This temperable steel has outstanding mechanical strength properties after warm forming. The sheet steel product (tailored blank) consisting of the steel sheets 8, 9 is subsequently shaped by warm forming to form a three-dimensional component, for example a vehicle door sheet.

By introducing, into the liquid weld pool 11, the carbon and/or another element which increases the strength of the weld seam 10, via the adjacent cut edges of the steel sheets 8, 9 in the form of highly viscous oils or liquids, a primary microstructure is selectively produced having an altered chemical composition by comparison with the microstructures of the materials of the connected steel sheets 8, 9. In this context, the welding material melt is preferably mixed simultaneously by using a mixed gas method. The primary microstructure, which has been altered in this manner, of the weld seam 10—after cooling (quenching) in the laser welding process, heating to a temperature above the austenisation temperature in the warm forming process, and subsequent cooling—has a secondary microstructure which is at least as hard as the basic materials which are connected by the welding, preferably harder. This applies both to subsequent cooling in the warm forming process (direct hot stamping) and to indirect warm forming (indirect hot stamping).

The oil or the carbon-containing liquid is selected and/or adjusted, as regards the carbon content thereof, in such a way that the weld seam 10—after abrupt cooling, heating to a temperature above the austenisation temperature, and further abrupt cooling—has a strength which is in the range of 1500 MPa to 2000 MPa, preferably in the range of 1700 MPa to 1900 MPa.

The weld seam 10—after abrupt cooling, heating to a temperature above the austenisation temperature, and further abrupt cooling—has a strength which is at least equal to, preferably at least 100 MPa higher than, more preferably at least 200 MPa higher than the strength of the steel blanks or steel strips 8, 9 which are connected by the welding. For this purpose, the content by mass of the carbon in the weld seam 10 is increased to 0.25 to 0.40% by weight, preferably to 0.30 to 0.40% by weight.

Assuming that the weld seam 10 is not converted back into a melted liquid state, the partial increase in the carbon content in the weld seam 10 is retained in all of the subsequent heat treatments. In this way, by the heat-treatment of the weld seam 10 in this region, a microstructure which is at least equally hard, preferably harder, is obtained.

The higher carbon supply in the weld seam 10 or defined regions of the weld seam causes the austenite to take up larger amounts of carbon during formation from the melted liquid phase, and as a result a more carbon-rich austenite is available for hardening in the weld seam 10 or in a defined region of a laser weld seam, and this is reflected in improved hardening.

In particular when stamping highly geometrically complex components, there are restrictions on the configuration of the shaping tools in relation to the production of the positive connection. In these cases, critical regions of the weld seam can be alloyed selectively with higher carbon contents, so as to produce martensitic microstructures in the weld seam 10 independently of the positive connection and thus of the cooling speed. Also, the selective hardening of weld seam regions which are to define break points in the finished component can be achieved constructively by the method according to the invention. Configurations of weld seam regions which have to have a particularly high strength as a result of particular loads are also conceivable when using the method according to the invention. With the method according to the invention, a comparatively cost-effective method of (partially) conferring different properties on the weld seam 10 is also available.

The implementation of the invention is not limited to the above-described embodiments. Rather, a number of variants are conceivable, and still make use of the invention specified in the appended patent claims, even if the configuration is different. Thus, for example, it is still within the scope of the invention to use an application roller, instead of a fluid line 4 which opens at the joint 7, to apply the highly viscous oil or the highly viscous carbon-containing liquid. It is also possible to apply solid substances or pulverulent or aerosol-like substances, and as a result the characteristics and properties of the weld seam can be set selectively during laser welding.

1-16. (canceled)

17. A method for producing sheet steel products, comprising:
welding together steel blanks or steel strips of different thicknesses and/or material grades along a joint formed by edges of the steel blanks or steel strips; and
before the welding process, applying a viscous liquid or a solid, pulverulent or aerosol-like substance to at least one weld edge of the steel blanks or steel strips that are to be welded together, wherein the viscous liquid or solid, pulverulent or aerosol-like substance contains at least one component that increases the strength of a weld seam that is to be produced.

18. The method according to claim 17, wherein the viscous liquid that is applied to the at least one weld edge of the steel blanks or steel strips is a paste.

19. The method according to claim 17, wherein the viscous liquid that is applied to the at least one weld edge of the steel blanks or steel strips is oil and/or grease.

20. The method according to claim 17, wherein the viscous liquid that is applied to the at least one weld edge of the steel blanks or steel strips is a liquid in which graphite particles are dispersed.

21. The method according to claim 17, wherein applying the viscous liquid or the solid, pulverulent or aerosol-like substance increases the content by mass of the carbon in the weld seam to 0.25 to 0.40% by weight.

22. The method according to claim 17, wherein applying the viscous liquid or the solid, pulverulent or aerosol-like substance increases the content by mass of the carbon in the weld seam to 0.30 to 0.40% by weight.

23. The method according to claim 17, wherein the liquid or the solid, pulverulent or aerosol-like substance is selected and/or adjusted, as regards the carbon content thereof, in such a way that the weld seam—after abrupt cooling, heating to a temperature above the austenization temperature, and further abrupt cooling—has a microstructure which is at least as hard as the steel blanks or steel strips that are connected by the welding.

24. The method according claim 17, wherein the liquid or the solid, pulverulent or aerosol-like substance is selected and/or adjusted, as regards the carbon content thereof, in such a way that the weld seam—after abrupt cooling, heating to a temperature above the austenization temperature, and further abrupt cooling—has a strength which is at least equal to the strength of the steel blanks or steel strips that are connected by the welding.

25. The method according claim 17, wherein the liquid or the solid, pulverulent or aerosol-like substance is selected and/or adjusted, as regards the carbon content thereof, in such a way that the weld seam—after abrupt cooling, heating to a temperature above the austenization temperature, and further abrupt cooling—has a strength which is at least 100 MPa higher than the strength of the steel blanks or steel strips that are connected by the welding.

26. The method according claim 17, wherein the liquid or the solid, pulverulent or aerosol-like substance is selected and/or adjusted, as regards the carbon content thereof, in such a way that the weld seam—after abrupt cooling, heating to a temperature above the austenization temperature, and further abrupt cooling—has a strength which is at least 200 MPa higher than the strength of the steel blanks or steel strips that are connected by the welding.

27. The method according to claim 17, wherein the viscous liquid or the solid, pulverulent or aerosol-like substance is selected and/or adjusted, as regards the carbon content thereof, in such a way that the weld seam—after abrupt cooling, heating to a temperature above the austenization temperature, and further abrupt cooling—has a strength which is in the range of 1500 MPa to 2000 MPa.

28. The method according to claim 17, wherein the viscous liquid or the solid, pulverulent or aerosol-like substance is selected and/or adjusted, as regards the carbon content thereof, in such a way that the weld seam—after abrupt cooling, heating to a temperature above the austenization temperature, and further abrupt cooling—has a strength which is in the range of 1700 MPa to 1900 MPa.

29. The method according to claim 17, wherein the steel blanks or steel strips are formed of manganese-boron steel.

30. The method according to claim 17, wherein the viscous liquid is applied in a concurrent operation alongside the welding.

31. The method according to claim 17, wherein the welded together steel blanks or steel strips are shaped by warm forming to form a three-dimensional component, optionally after being cut one or more times.

32. The method according to claim 17, wherein the liquid that contains the at least one component that increases the strength has a kinematic viscosity of at least 50×10⁻⁶ m²/s at an ambient temperature of 20° C.

33. The method according to claim 17, wherein the liquid that contains the at least one component that increases the strength has a kinematic viscosity of at least 100×10⁻⁶ m²/s at an ambient temperature of 20° C.

34. The method according to claim 17, wherein the liquid that contains the at least one component that increases the strength has a kinematic viscosity of at least 500×10⁻⁶ m²/s at an ambient temperature of 20° C.

35. The method according to claim 17, wherein the at least one component is carbon.

36. A sheet steel product comprising steel blanks or steel strips of different thicknesses and/or material grades that are welded together along a joint, wherein a weld seam thereof—after abrupt cooling, heating to a temperature above the austenization temperature, and further abrupt cooling—has a microstructure which is at least as hard as the steel blanks or steel strips that are connected by the welding.

37. The sheet steel product according to claim 36, wherein the weld seam—after abrupt cooling, heating to a temperature above the austenization temperature, and further abrupt cooling—has a strength that is at least equal to the strength of the steel blanks or steel strips that are connected by the welding.

38. The sheet steel product according to claim 36, wherein the weld seam—after abrupt cooling, heating to a temperature above the austenization temperature, and further abrupt cooling—has a strength that is at least 100 MPa higher than the strength of the steel blanks or steel strips that are connected by the welding.

39. The sheet steel product according to claim 36, wherein the weld seam—after abrupt cooling, heating to a temperature above the austenization temperature, and further abrupt cooling—has a strength that is at least 200 MPa higher than the strength of the steel blanks or steel strips that are connected by the welding.

40. The sheet steel product according to claim 36, wherein the weld seam—after abrupt cooling, heating to a temperature above the austenization temperature, and further abrupt cooling—has a strength which is in the range of 1500 MPa to 2000 MPa.

41. The sheet steel product according to claim 36, wherein the weld seam—after abrupt cooling, heating to a temperature above the austenization temperature, and further abrupt cooling—has a strength which is in the range of 1700 MPa to 1900 MPa.

42. The sheet steel product according to claim 36, wherein the weld seam thereof has a carbon content of at least 0.25 to 0.40% by weight.

43. The sheet steel product according to claim 36, wherein the weld seam thereof has a carbon content of at least 0.30 to 0.40% by weight.

44. The sheet steel product according to claim 36, wherein the steel blanks or steel strips are formed of manganese-boron steel.

45. A warm-formed component produced from the sheet steel product according to claim 36.
